(19) United States
(12) Patent Application Publication
(10) Pub. No.: US 2010/0003372 A1
(43) Pub. Date: Jan. 7, 2010

(54) DEVICE AND METHOD FOR NESTING FOOD PRODUCTS

(76) Inventor: Lee Golani, Fort Wayne, IN (US)

Correspondence Address: BARNES & THORNBURG LLP, 600 ONE SUMMIT SQUARE, FORT WAYNE, IN, 46802, US

(21) Appl. No.: 12/495,086

(22) Filed: Jun. 30, 2009

Related U.S. Application Data
(60) Provisional application No. 61/077,916, filed on Jul. 3, 2008.

(51) Int. Cl. A23L 1/31; A23L 1/315; A23L 1/33; A47J 43/18

(52) U.S. Cl. 426/92; 426/282; 99/421 A

(57) ABSTRACT

A tool for nesting food products, a food product prepared by a process and a method for nesting food products. The tool includes a body defining a passageway between a plunger opening and an insertion outlet. The body includes a pointed member extending from the insertion outlet. A plunger may be provided that is dimensioned to be received within the passageway. At least a portion of the plunger is movable between the plunger opening and the insertion outlet. The passageway is dimensioned to receive a shrimp-like product. Typically, movement of the plunger to the insertion outlet moves the shrimp-like product along the passageway and out through the insertion outlet.

### RELATED APPLICATION

This application claims priority to U.S. Provisional Application Ser. No. 61/077,916, filed Jul. 3, 2008, the entire disclosure of which is hereby incorporated by reference.

### TECHNICAL FIELD

The invention generally relates to edible food products; in particular, the invention relates to a device and method for nesting one food product into another food product.

### BACKGROUND

In the food industry, people enjoy various types of food from the fast food industry to the most gourmet of meals. People love to eat such foods as buffalo wings whether it has been fried, baked, or even bar-b-qued. People love to eat shrimp in the same manner it can be prepared fried, baked, boiled or served cold and it can even be bar-b-qued. The only thing missing is to have both buffalo wings and shrimp as a single unit. If the buffalo wings and shrimp were one entity, considered a new food, it can also be prepared by frying, baking, and even bar-b-queing and people can have the best of both worlds.

### SUMMARY

In one aspect, the invention provides a tool for nesting food products. The tool includes a body defining a passageway between a plunger opening and an insertion outlet. The body includes a pointed member extending from the insertion outlet. A plunger may be provided that is dimensioned to be received within the passageway. At least a portion of the plunger is movable between the plunger opening and the insertion outlet. The passageway is dimensioned to receive a shrimp-like product. Typically, movement of the plunger to the insertion outlet moves the shrimp-like product along the passageway and out through the insertion outlet.

In some cases, the pointed member includes a tapered portion extending from the plunger opening. Embodiments are contemplated in which the pointed member includes a needle-like portion extending from the tapered portion that terminates at a tip. In some embodiments, the tapered portion could be substantially planar in shape and/or the needle-like portion could be approximately cylindrical in shape. Typically, the needle-like portion is substantially solid. Depending on the circumstances, the body might have a bottom wall spaced apart from a top wall and a first sidewall spaced apart from a second sidewall. In such cases, the first sidewall and the second sidewall could extend between the bottom wall and the top wall. In some embodiments, the first sidewall and the second sidewall might be tapered at the insertion outlet. Embodiments are contemplated in which the top wall defines a window for inserting a food product into the passageway. Preferably, the window is dimensioned to receive a shrimp-like product. In some cases, the bottom wall and the pointed member could be substantially coplanar.

According to another aspect, the invention provides a food product prepared by a process in which a poultry piece with meat surrounded by skin and a shrimp-like product including a tail are provided. A nesting tool could be provided with a body defining a passageway between a plunger opening and an insertion outlet. The tool's body may include a pointed member extending from the insertion outlet. The process may include the step of piercing the skin of the poultry piece with the pointed member of the tool to provide an insertion point. The skin surrounding the insertion point is extended away from the meat. The shrimp-like product is placed in the passageway of the nesting tool and inserted through the insertion point to be nested between the skin and meat of the poultry piece to form a nested food product. Typically, at least a portion of the tail is external to the poultry piece.

In some embodiments, the shrimp-like product is placed in the passageway with the tail oriented away from the insertion outlet. The inserting step may include pushing the shrimp-like product through the insertion outlet. Embodiments are contemplated in which the poultry piece is a poultry wing. At some point, the nested food product is typically cooked.

According to a further aspect, the invention provides a method of preparing a nested food product. The method includes the step of providing a poultry piece with meat surrounded by skin and a shrimp-like product including a tail. The skin of the poultry piece is pierced to provide an insertion point. The skin is extended away from the meat on the poultry piece in an area surrounding the insertion point. The method also includes the step of inserting at least a portion of the shrimp-like product through the insertion point so the shrimp-like product is nested between the skin and meat of the poultry piece to form a nested food product. Typically, at least a portion of the tail is external to the poultry piece. In some cases, the poultry piece is a poultry wing and the shrimp-like product is a shrimp or prawn.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a perspective view of an example tool for nesting a first food product with a second food product according to an embodiment of the invention;

FIG. 2A is a top view of the example tool shown in FIG. 1 with the plunger removed from the body;

FIG. 2B is the example tool shown in FIG. 2A with the plunger inserted into the body;

FIG. 3 is a right side view of the example tool shown in FIG. 1 without the plunger;

FIG. 4 is a front view of the example tool shown in FIG. 1;

FIG. 5 is a perspective view of the example tool of FIG. 1 initially inserted under the skin of a poultry piece;

FIG. 6 is a fragmentary view of the example tool of FIG. 1 similarly positioned as FIG. 5, but with the tool fully inserted under the poultry piece's skin to extend the skin of the away from the meat;

FIG. 7 is a fragmentary view of the example tool of FIG. 1 positioned under the poultry piece's skin as with FIG. 6, but with a shellfish placed in the tool's passageway;

FIG. 8 is a perspective view of the example tool of FIG. 1 showing the plunger moved to push the shellfish into the poultry piece; and

FIG. 9 is a fragmentary view showing the nested food product removed from the tool.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

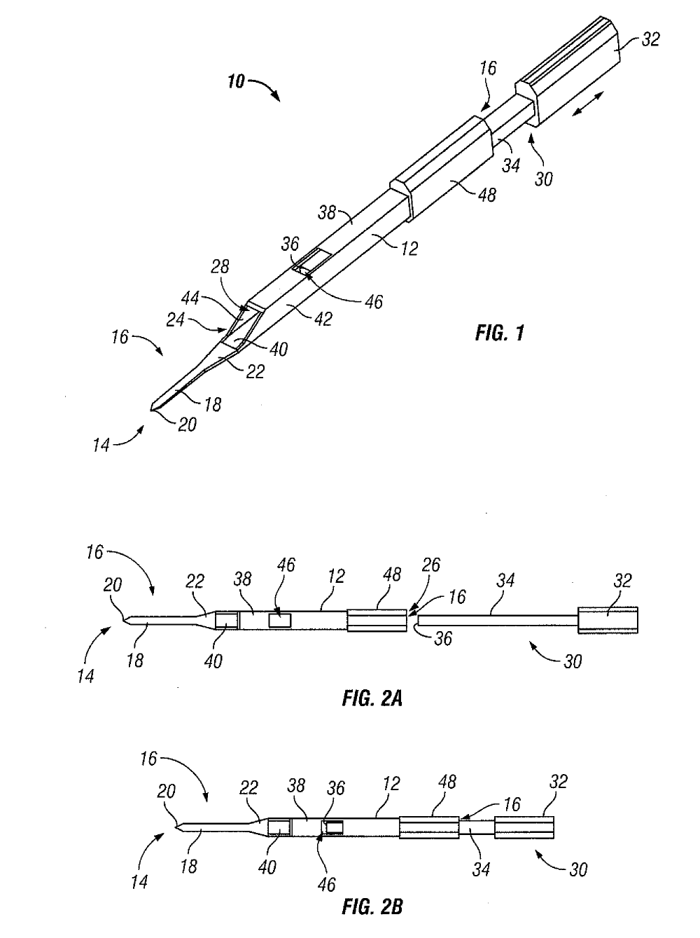

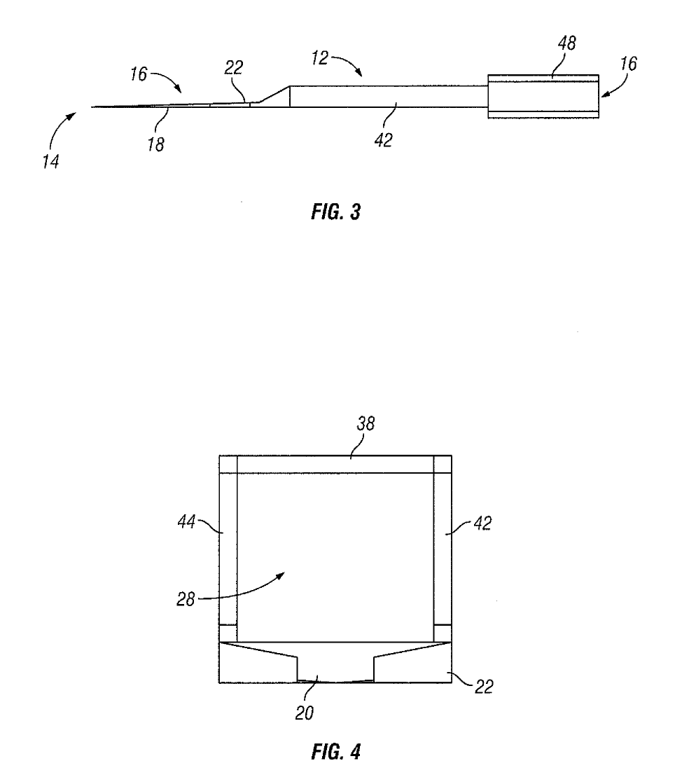

FIGS. 1-4 show an example tool 10 that can be used for nesting one food product with a second food product to create a nest food product. Although the tool 10 will be described herein with respect to nesting a poultry piece, such as chicken or turkey wings, and shellfish, such as shrimp or prawn, embodiments are contemplated in which other types of food products could be nested. Moreover, it is contemplated that more than two food products could be nested in some embodiments. In some embodiments, the tool 10 could be formed from food grade plastic or could be metallic, such as stainless steel, or a combination of materials.

In the example shown in the drawings, the tool 10 has a body 12 with a first end 14 and a second end 16. As shown, the first end 14 has a pointed member 16 for piercing the skin of a poultry piece (or other food product) to provide an insertion point for nesting the shellfish (or other food product) between the meat and skin of the poultry piece. In this example, the pointed member 16 includes a needle-like portion 18 that terminates at a tip 20 and includes a tapered portion 22. Since the food product to be nested is not inserted through the needle-like portion 18, there is no need for the needle-like portion 18 to be hollow and could be solid if desired. In some embodiments, the tapered portion 22 could be sharp enough to create a groove in the skin, which allows the skin to be stretched without ripping when the tool 10 is fully inserted.

As shown, the body 12 includes a passageway 24 between a plunger opening 26 and an insertion outlet 28. The passageway 24 is dimensioned to receive a shellfish (or other food product to be nested). The plunger opening 26 is dimensioned to receive a plunger 30 for moving the food product to be nested (e.g., shellfish) in the passageway 24 and out the insertion outlet 28. In the example shown, the plunger 30 includes a handle 32 and a pushing portion 34. As shown, the leading end 36 of the pushing portion 34 moves the shellfish (or other food product) in the passageway 24. Preferably, the pushing portion 34 has sufficient length to push the shellfish through the passageway 24, but leaving the tail of the shellfish just inside the insertion outlet 28. In some embodiments, the handle 32 could include surface ornamentation, such as a knurled surface, to ease in gripping of the handle 32.

In the example shown, the insertion outlet 28 is defined by the ends of a top wall 38, a bottom wall 40, a first sidewall 42, and a second sidewall 44. Although the body 12 is shown with four walls for purposes of example, embodiments are contemplated in which the body 12 could include more and less walls. For example, the body 12 could be a U-shaped member that defines a passageway without a top wall. Even though the walls 38, 40, 42, 44 are substantially planar in the example shown in the drawings, embodiments are contemplated in which the walls 38, 40, 42, 44 could be curved or arcuate in shape or other shapes. In the example shown, the sidewalls 42, 44 are tapered so that the insertion outlet 28 is on a bias. The tapered side walls 42, 44 extend the poultry piece's skin away from the meat so that the shellfish (or other food product) can be inserted therebetween. As shown, the bottom wall 40 is approximately coplanar with the pointed member 16. In the embodiment shown, a window 46 is defined in the top wall 38 for placing the shellfish (or other food product to be nested) in the passageway 24. In some cases, a grip 48 could be formed proximate the plunger opening 26 for the user to grasp the body 12 when grasping the handle 32 to nest a shell fish with the poultry piece.

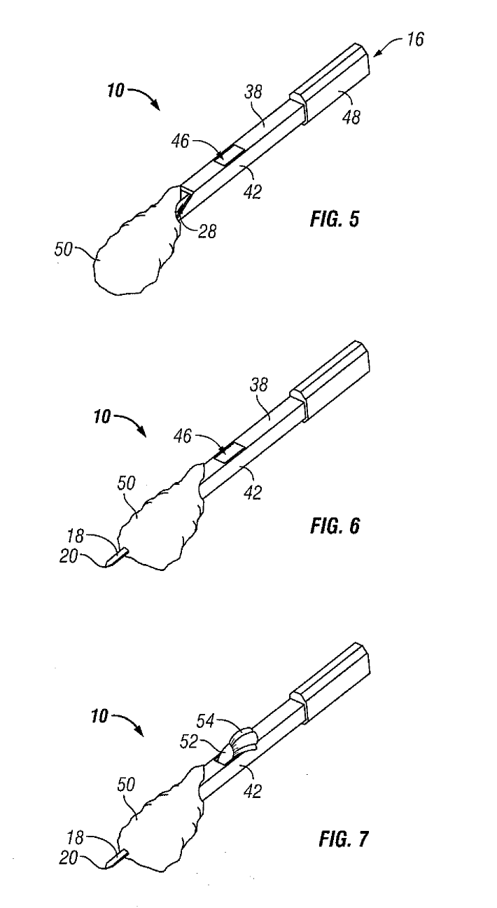

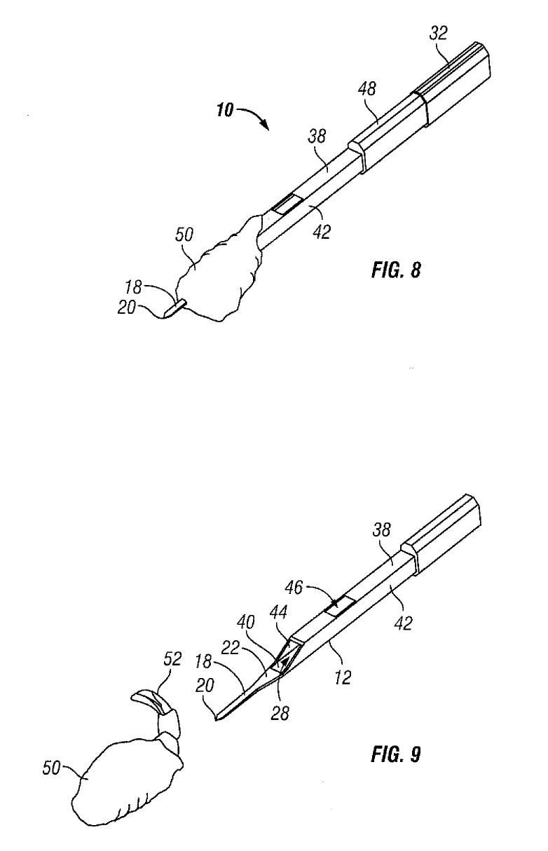

FIGS. 5-9 show a manner in which the tool 10 may be used to create a nested food product. FIG. 5 shows the example tool 10 after initially piercing the skin of a poultry piece 50 into which another food product, such as a shellfish, will be nested. The opening in the skin of the poultry piece 50 provides an insertion point through which the other food product (e.g., shrimp) can be inserted. Although a chicken wing is shown for purposes of example, it should be appreciated that other types of food products could be used for nesting, including but not limited to, turkey wings. FIG. 6 shows further insertion of the tool 10 into the poultry piece 50, which extends the skin away from the meat to create a gap. The tapered sidewalls 42, 44 provide a bias that stretches the skin of the poultry to create the gap between the skin and meat; however, the tool 10 is not intended to penetrate the poultry piece's meat. Typically, the tool 10 is inserted under the skin approximately the length of the shellfish (or other food product) to be inserted. FIG. 7 shows an example shellfish 52 with a tail 54 to be nested with the poultry piece 50. In the example shown, the shellfish 52 is placed in the passageway 24 via the window 46 defined in the top wall 38. Typically, the shellfish 52 is oriented in the passageway 24 so the tail 54 extends away from the poultry piece 50. The shellfish 52 is pushed, in this example, with the leading end 36 of the plunger 30, into the gap between the tool 10 and the poultry's skin. In this example, the tail 54 is not inserted into the poultry piece 50, but extends out of the poultry piece 50. With pressure on the poultry piece 50 and nested portion of shellfish 52, the tool 10 is removed from under the skin, as shown in FIG. 9.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A tool for nesting food products, the tool comprising:
a body defining a passageway between a plunger opening and an insertion outlet, wherein the body includes a pointed member extending from the insertion outlet;
a plunger dimensioned to be received within the passageway, wherein at least a portion of the plunger is movable between the plunger opening and the insertion outlet;
wherein the passageway is dimensioned to receive a shrimp-like product; and
wherein movement of the plunger to the insertion outlet moves the shrimp-like product along the passageway and out through the insertion outlet.

2. The tool of claim 1, wherein the pointed member includes a tapered portion extending from the plunger opening.

3. The tool of claim 2, wherein the pointed member includes a needle-like portion extending from the tapered portion that terminates at a tip.

4. The tool of claim 3, wherein the tapered portion is substantially planar in shape.

5. The tool of claim 4, wherein the needle-like portion is approximately cylindrical in shape.

6. The tool of claim 5, wherein the needle-like portion is substantially solid.

7. The tool of claim 1, wherein the body includes a bottom wall spaced apart from a top wall and a first sidewall spaced apart from a second sidewall, wherein the first sidewall and the second sidewall extend between the bottom wall and the top wall.

8. The tool of claim 7, wherein the first sidewall and the second sidewall are tapered at the insertion outlet.

9. The tool of claim 7, wherein the top wall defines a window for inserting a food product into the passageway, wherein the window is dimensioned to receive a shrimp-like product.

10. The tool of claim 7, wherein the bottom wall and the pointed member are substantially coplanar.

11. The tool of claim 7, wherein the body is substantially metallic.

12. The tool of claim 11, wherein the body is substantially formed from stainless steel.

13. The tool of claim 7, wherein at least a portion of the body is includes a portion that is substantially a hollow rectangular prism.

14. A food product prepared by a process comprising the steps of:
providing a poultry piece with meat surrounded by skin and a shrimp-like product including a tail;
providing a nesting tool with a body defining a passageway between a plunger opening and an insertion outlet, wherein the body includes a pointed member extending from the insertion outlet;
piercing the skin of the poultry piece with the pointed member to provide an insertion point;
extending the skin of the poultry piece away from the meat in an area surrounding the insertion point;
placing the shrimp-like product in the passageway of the nesting tool;
inserting at least a portion of the shrimp-like product through the insertion point so the shrimp-like product is nested between the skin and meat of the poultry piece to form a nested food product; and
wherein at least a portion of the tail is external to the poultry piece.

15. The food product of claim 14, wherein the shrimp-like product is placed in the passageway with the tail oriented away from the insertion outlet.

16. The food product of claim 15, wherein the inserting step includes pushing the shrimp-like product through the insertion outlet.

17. The food product of claim 14, wherein the poultry piece is a poultry wing.

18. The food product of claim 14, further comprising the step of cooking the nested food product.

19. A method of preparing a food product comprising the steps of:
providing a poultry piece with meat surrounded by skin and a shrimp-like product including a tail;
piercing the skin of the poultry piece to provide an insertion point;
extending the skin of the poultry piece away from the meat in an area surrounding the insertion point;
inserting at least a portion of the shrimp-like product through the insertion point so the shrimp-like product is nested between the skin and meat of the poultry piece to form a nested food product; and
wherein at least a portion of the tail is external to the poultry piece.

20. The method of claim 19, wherein the poultry piece is a poultry wing and the shrimp-like product is a shrimp or a prawn.
